(19) United States
(12) Patent Application Publication
(10) Pub. No.: US 2008/0270198 A1
(43) Pub. Date: Oct. 30, 2008

(54) Systems and Methods for Providing Remediation Recommendations

(75) Inventors: David Graves, Monte Sereno, CA (US); Adrian John Baldwin, Bristol (GB); Yolanta Beresnevichiene, Bristol (GB); Philippe Lamy, Mountain View, CA (US); Simon Kai-Ying Shiu, Bristol (GB)

Correspondence Address: Hewlett-Packard Company, Intellectual Property Administration, PO Box 272400, Ft. Collins, CO, 80527-2400, US

(73) Assignee: HEWLETT-PACKARD DEVELOPMENT COMPANY, L.P., Ft. Collins, CO (US)

(21) Appl. No.: 11/739,839

(22) Filed: Apr. 25, 2007

(51) Int. Cl. G06Q 99/00

(52) U.S. Cl. 705/7

(57) ABSTRACT

In one embodiment, a system and method pertain to receiving audit exceptions indicative of instances of noncompliance of an information system under evaluation relative to a policy or standard, identifying remediation recommendations that are relevant to the audit exceptions and that indicate how to correct conditions that caused the noncompliance, and providing the remediation recommendations to an entity responsible for correcting the conditions so as to provide information as to how the information system can be brought into compliance with the policy or standard.

### BACKGROUND

In the present climate of growing regulatory mandates and industry-based requirements, business organizations are being forced to more vigorously examine the effectiveness of their internal information technology (IT) controls and processes. Indeed, regulations such as the Sarbanes-Oxley Act, the Health Insurance Portability and Accountability Act (HIPAA), and the Graham-Leach-Biley Act require organizations to demonstrate that their internal IT controls and processes are appropriate. In view of such requirements, information system security managers and owners are under increased pressure to provide more timely assurance that their controls and processes are working effectively and that risk is being properly managed.

Traditionally, the compliance of information systems is evaluated on an annual basis. For example, one or more auditors may conduct an annual audit on a given information system relative to one or more sets of policies or standards to determine how closely the information system and its use complies with those policies/standards. Typically, the results of the audit are published in a lengthy report that may identify multiple problems with the information system and/or its use. Although such a report is useful in that it alerts the responsible persons as to areas that require remediation, the report may include hundreds of items that require action. One reason that the report may contain so many items is that manual auditing is both time consuming and expensive and therefore cannot practically be performed on a frequent basis. Therefore, by the time the audit is performed, many problems may have occurred that require action. In such a case, the persons responsible for resolving the problems, such as IT professionals, may be overwhelmed by the sheer number of tasks that they must perform. Adding to the difficulty of the responsible persons' task is the fact that low priority items may be listed together with high priority items without distinction, therefore making it difficult for the responsible persons to identify what problems must be addressed more immediately. Even when such difficulties do not exist, the responsible persons may not know how to resolve one or more of the problems given that audit reports normally only identify problems, not solutions.

### BRIEF DESCRIPTION OF THE DRAWINGS

The components in the drawings are not necessarily to scale, emphasis instead being placed upon clearly illustrating the principles of the present disclosure. In the drawings, like reference numerals designate corresponding parts throughout the several views.

FIG. 1 is schematic diagram of an embodiment of operational infrastructure of an information system for which remediation recommendations can be automatically generated.

FIG. 2 is a block diagram of an embodiment of a computer that comprises an automated remediation recommendation system configured to generate remediation recommendations.

FIG. 3 is block diagram of an embodiment of a continuous compliance monitoring and modeling module shown in FIG. 2.

FIG. 4 is block diagram of embodiment of an external remediation system and a remediation processor shown in FIG. 2, illustrating interaction between the remediation system and the remediation processor.

FIGS. 5A and 5B illustrate an embodiment of a method for automatically providing remediation recommendations relative to identified audit exceptions.

FIG. 6 illustrates a first example remediation recommendation notification.

FIG. 7 illustrates a second example remediation recommendation notification.

FIG. 8 is a flow diagram that illustrates an embodiment of a method for configuring the automated remediation recommendation system.

### DETAILED DESCRIPTION

As described above, current methods for identifying problems with an information system can be disadvantageous. For example, the persons responsible for remedying the problems may be overwhelmed by the number of issues identified in an audit report. Furthermore, those persons may not know how to resolve an identified issue given that audit reports typically do not identify solutions to discovered problems.

As described in the following, such disadvantages can be reduced or eliminated by automatically evaluating an information system to identify problems with the system and/or its use and automatically providing remediation recommendations for resolving those problems. Given that the evaluation is automated, it can be performed on a relatively frequent basis, for example every month, week, or day. Assuming the problems identified through the evaluation are addressed in a timely manner, the number of problems that will be contained in an annual audit report may be reduced. Furthermore, given that remediation recommendations are provided, occurrences in which a responsible person does not know how to resolve the problem may be less frequent.

In the following, various system and method embodiments are disclosed. Although specific embodiments are described, those embodiments are mere example implementations. Therefore, other embodiments are possible. All such embodiments are intended to fall within the scope of this disclosure.

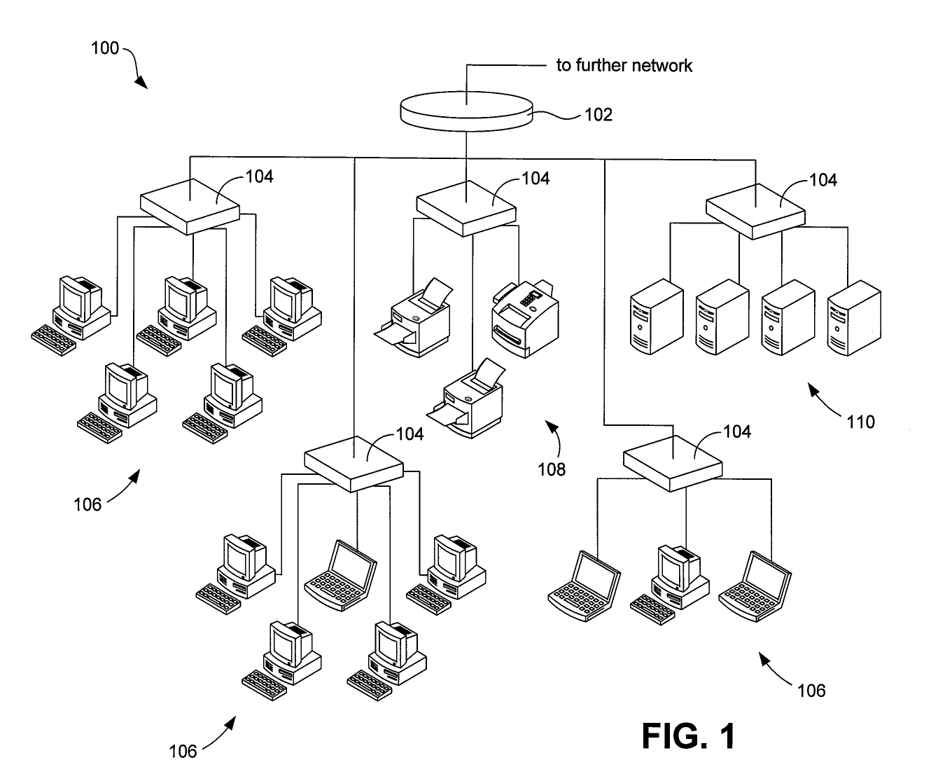

Referring now to the drawings, in which like numerals indicate corresponding parts throughout the several views, FIG. 1 illustrates an example operational infrastructure 100 of an information system that is to comply with certain policies established by the system owner or operator and/or with standards (e.g., regulations) imposed by an external entity (e.g., government). As is apparent from FIG. 1, the infrastructure 100 may define a network or part of a network, such as a local area network (LAN), that can be connected to and communicate with another network, such as another LAN or a wide area network (WAN). In the example of FIG. 1, the infrastructure 100 includes a router 102 that routes data to and from multiple switches 104, to which multiple network-enabled devices are connected. In FIG. 1, the devices connected to the switches 104 include client computers 106, peripheral devices 108, and server and/or storage computers 110.

The client computers 106 can comprise desktop computers as well as laptop computers. The peripheral devices 108 can comprise printing devices to which print jobs generated by the client computers 106 can be sent for processing. Such printing devices may comprise dedicated printers, or may comprise multifunction devices that are capable of printing as well as other functionalities, such as copying, emailing, faxing, and the like. The server computers 110 may be used to administer one or more processes for the infrastructure 100. For example, one server computer may act in the capacity as a central storage area, another server computer may act in the capacity of a print server, another server computer may act as a proxy server, and so forth.

Generally speaking, each of the devices of the infrastructure 100, including the router 102 and the switches 104, participate in operation of the information system and therefore may need to be checked for compliance with one or more policies and/or standards. It is noted that although relatively few devices are shown in FIG. 1 by way of example, the information system under evaluation and its infrastructure may comprise many, such as hundreds or even thousands, of such devices, thereby making manual auditing relatively challenging. Furthermore, although the information system is shown as comprising only client computers, printing devices, and server computers, the system may comprise any number of other types of devices that also define the information system and characterize its operation and use.

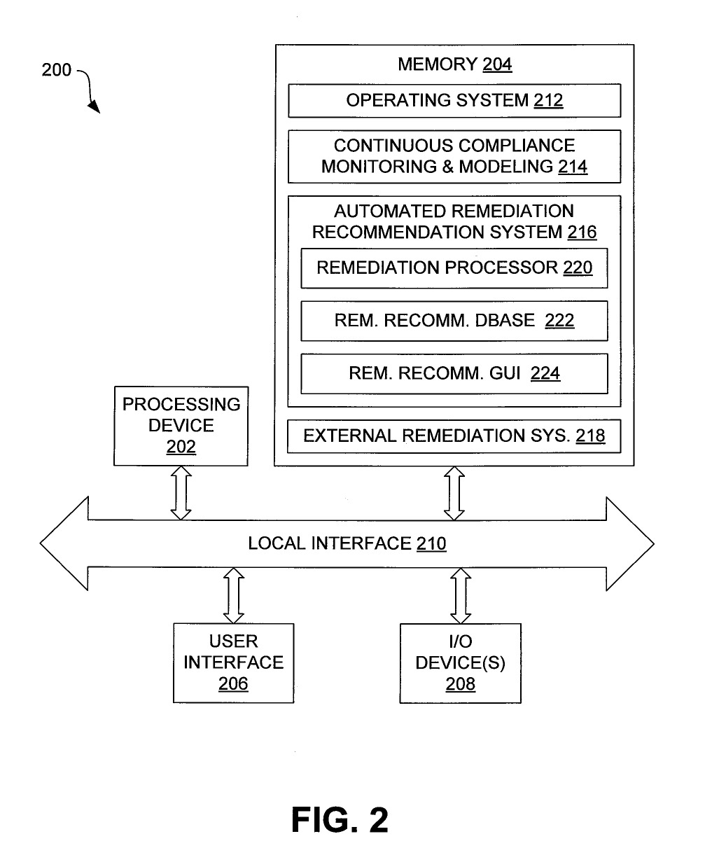

FIG. 2 is a block diagram illustrating an example architecture for a computer 200 that can be used to evaluate the infrastructure 100 of FIG. 1 and automatically provide remediation. In some embodiments, the computer can be one of the client computers 106 or one of the server computers 110. In other embodiments, the computer 200 can be external to the infrastructure 100. Regardless, the computer 200 comprises a processing device 202, memory 204, a user interface 206, and at least one I/O device 208, each of which is connected to a local interface 210.

The processing device 202 can include a central processing unit (CPU) or a semiconductor-based microprocessor. The memory 204 includes any one of a combination of volatile memory elements (e.g., RAM) and nonvolatile memory elements (e.g., hard disk, ROM, tape, etc.).

The user interface 206 comprises the components with which a user interacts with the computer 200. The user interface 206 may comprise, for example, a keyboard, mouse, and a display, such as a cathode ray tube (CRT) or liquid crystal display (LCD) monitor. The one or more I/O devices 208 are adapted to facilitate communications with other devices and may include one or more communication components, such as a wireless (e.g., radio frequency (RF)) transceiver, a network card, etc.

In the embodiment of FIG. 2, the memory 204 comprises various programs including an operating system 212, a continuous compliance monitoring and modeling system 214 (“CCMM”), an automated remediation recommendation system 216, and an external remediation system 218. The operating system 212 controls the execution of other programs and provides scheduling, input-output control, file and data management, memory management, and communication control and related services. As described in greater detail below, the CCMM 214 is an automated evaluation system that monitors the infrastructure of an information system under evaluation, automatically evaluates compliance of the information system and its operation relative to one or more established policies and/or standards, and automatically identifies instances of non-compliance (i.e., problems) that must be remedied to achieve full compliance with the applicable policies and/or standards. As is also described in greater detail below, the automated remediation recommendation system 216 obtains information from the CCMM 214 as to any problems that exist, automatically identifies solutions to those problems including recommended steps that can be performed to resolve the problems, and, when deemed desirable, automatically notifies responsible entities as to those solutions. In at least some embodiments, the external remediation system 218 assists the automated remediation recommendation system 216 in delivering the notifications to the appropriate entities.

As is further shown in FIG. 2, the automated remediation recommendation system 216 can, at least in some embodiments, comprise a remediation processor 220 that identifies appropriate recommendations and generates the notifications, a remediation recommendation database 222 that stores information as to what actions are recommended in relation to various problems, and a remediation recommendation graphical user interface (GUI) 224 that can be used by a user, such as a system administrator or auditor, to initialize and control operation of the automated remediation recommendation system 216. In alternative embodiments, the remediation recommendation database 222 and the remediation recommendation GUI 224 can comprise subcomponents of the CCMM 214.

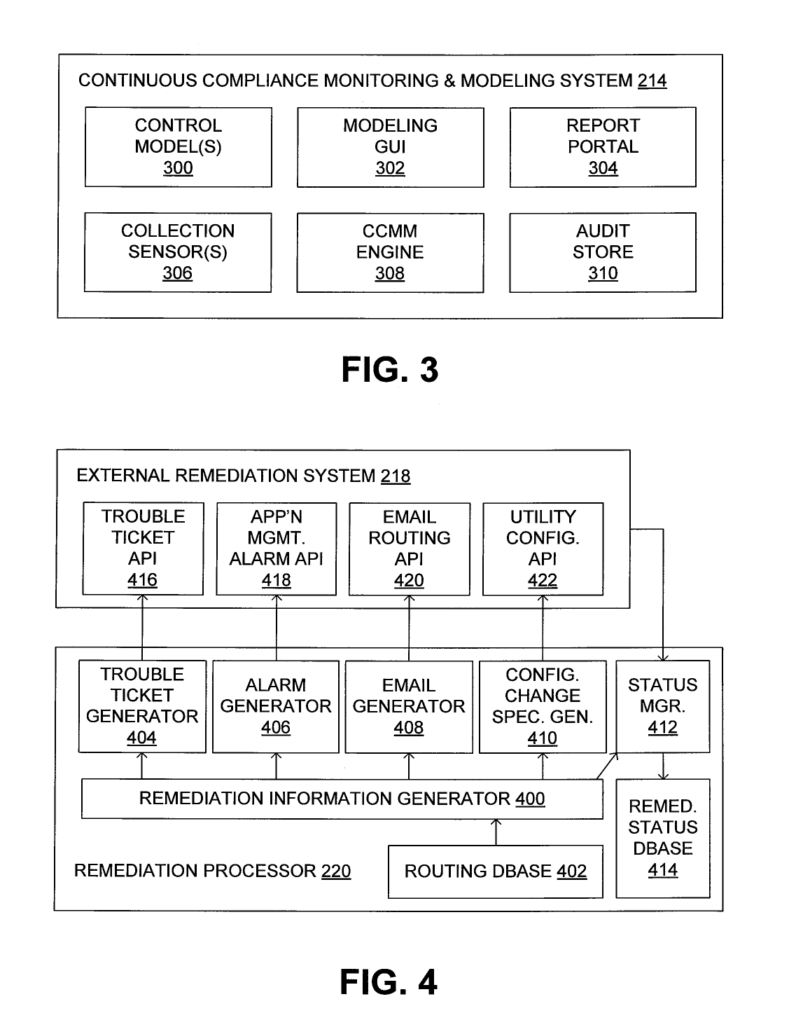

FIG. 3 illustrates an example configuration for the CCMM 214 shown in FIG. 2. As mentioned above, the CCMM 214 is configured to monitor the infrastructure of an information system under evaluation, automatically evaluate compliance of the information system and its operation relative to one or more established policies and/or standards, and automatically identify problems that must be remedied to achieve full compliance with the applicable policies and/or standards. Therefore, the CCMM 214 automates the tasks normally performed by one or more human auditors during an annual audit. As indicated in FIG. 3, the CCMM 214 includes one or more control models 300, a modeling GUI 302, a report portal 304, one or more collection sensors 306, a CCMM engine 308, and an audit store 310.

The control models 300 comprise computer-readable versions of the policies and/or standards applicable to the information system under evaluation. Given that compliance of the information system is determined relative to those policies and/or standards, the control models 300 drive the evaluation process. The control models 300 specify the data sources and the operations to be performed on the data that is collected. Because the control models 300 capture security and audit processes in a rigorous manner, the models form a foundation for incremental improvement of the information system from a compliance standpoint. A library of control models 300 can be provided, representing any number of policy sets and standards from which compliance can be independently or collectively judged.

The modeling GUI 302 provides an interface for a user, such as a system administrator or auditor, to create and modify the control models 300. In at least some embodiments, the modeling GUI 302 provides a simple graphical environment for defining each model 300 that can be used with a minimal understanding of computer programming.

The report portal 304 controls access to automatically generated reports that describe the findings obtained through the evaluation of the information system. In some embodiments, the report portal 304 takes the form of a web site that authorized persons can access to view the reports. The reports document the results of automated security and audit processes as specified by the control models 300. The reports can provide anywhere from a high-level indication of the system's compliance with few details to a low-level indication of compliance including a great amount of detail. As described below, select report content can also be forwarded as a notification to a responsible entity. Such a notification can, for example, take the form of a trouble ticket entered into a workflow system, as an alarm entered into an application management system, as an email message sent to a responsible person, or as a change specification provided to an automated remediation utility such as a utility computing application. A user can review controls documentation to understand the model that has been applied and then review the resulting report to understand the results obtained through analysis of evidence collected during the evaluation.

The collection sensors 306 comprise components and/or instrumentations that extract data from the operational infrastructure of the information system under evaluation. Therefore, the sensors 306 are used by the CCMM 214 to cull the various data from the infrastructure that will be used to determine how well the information system complies with the applicable policies and/or standards. There are multiple sources from which the sensors 306 can obtain evidence in an unobtrusive manner, such as security and audit information in a data warehouse, the application programming interface (API) of an enterprise application, and log files from infrastructure devices or applications.

The CCMM engine 308 comprises the “intelligence” of the CCMM 214 and controls overall operation of the CCMM. More specifically, the CCMM engine 308 reviews the control models 300 that are to be applied in the evaluation, drives the collection of evidence pertinent to the control models using the sensors 306, processes the collected evidence relative to the control models, and generates and formats the reports that are accessible to a user via the report portal 304. Notably, the CCMM engine 308 can rapidly adapt to new security and audit models and changes to the CCMM engine software are typically not required. To exploit a new type of security or audit control, all that are required are a new model 300 and appropriate sensors 306 to collect the data for the model. The formatting of the report is automatically changed by the CCMM engine 308 relative to the model 300 that has been applied.

The audit store 310 serves as a repository for intermediate results as specified by the control models 300 and, therefore, can be used to store information collected by the sensors 306. In addition, the audit store 310 can be used to store the final results, including any reports generated by the CCMM engine 308. In some embodiments, the audit store 310 is deployed as a MySQL database on a Windows platform or as an Oracle database. In other embodiments, the audit store 310 comprises a generic store that is implemented with a relational database management system (RDBMS).

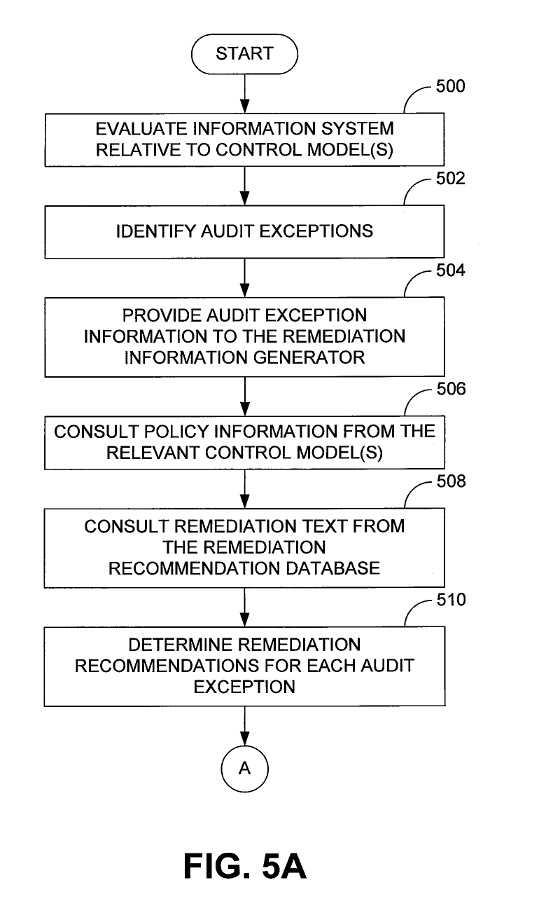

FIG. 4 illustrates an example configuration of the external remediation system 218 and the remediation processor 220 shown in FIG. 2, and illustrates interaction between them in providing remediation recommendations to a responsible entity, be it a human being or an automated remediation utility. In the embodiment of FIG. 4, the remediation processor 220 comprises a remediation information generator 400, a routing database 402, a trouble ticket generator 404, an alarm generator 406, an email generator 408, a configuration change specification generator 410, a status manager 412, and a remediation status database 414. Notably, one or both of the routing database 402 and the remediation status database 414 can be separate from the remediation processor 220 in alternative embodiments. In the following description, however, it is assumed that both databases 402, 414 are comprised by the remediation processor 220.

The remediation information generator 400 comprises the “intelligence” of the remediation processor 220 and therefore controls general operation of the processor. As its name implies, the remediation information generator 400 generates remediation information that can be provided to responsible entities to enable problems discovered by the CCMM 214 to be resolved in an effort to secure full compliance with policies and/or standards. As mentioned above, the remediation information can take the form of various remediation steps or actions that should be performed to rectify a problem with the information system. Therefore, explicit instruction as to how to resolve problems can be used by persons who otherwise may not know how to resolve the problems. The remediation information generator 400 generates the remediation information relative to information obtained from the control models 300 (FIG. 3), the CCMM engine 308 (FIG. 3), and from the remediation recommendation database 222 (FIG. 2). In particular, the remediation information generator 400 obtains information as to the various rules defined by the applicable policies and/or standards from the control models 300 and obtains indications of audit exceptions (i.e., problems) from the CCMM engine 308. In addition, the remediation information generator 400 obtains information regarding the priority of the audit exceptions in relation to severity and/or time sensitivity. The remediation information generator 400 can then use that information to identify the appropriate remediation recommendations contained in the remediation recommendation database 222 and select an appropriate notification mechanism with which to distribute the recommendations.

Once the remediation information generator 400 has identified the applicable remediation recommendations, the remediation processor 220 can provide those recommendations to the appropriate entities responsible for remedying any non-compliance in notifications. Various forms of notification can be used. For example, the remediation processor 220 can generate trouble tickets to be provided into a workflow system using the trouble ticket generator 404. Alternatively, the remediation processor 220 can generate alarms to be provided to an application management system using the alarm generator 406. As a further alternative, the remediation processor 220 can generate email messages to be sent to a responsible person using the email generator 408. In yet another alternative, the remediation processor 220 can generate a configuration change specification to be provided to an automated remediation utility using the configuration change specification generator 410. In each of the above notification mechanisms except the configuration change specification, information is generated for the review of a human being. In the case of the configuration change specification, however, the remediation information is used by the automated remediation utility to automatically fix the problems associated with the information system. Example automated remediation utilities are described in U.S. patent application Ser. No. 11/047,792, filed Jan. 31, 2005, which is hereby incorporated by reference in its entirety.

In some embodiments, the remediation processor 220 selects the appropriate notification mechanism and format for distribution of the remediation information based upon the priority of the conditions underlying the audit exceptions relative to thresholds established for those mechanisms. Therefore, high priority exceptions can be reported, for example, using an alarm while lower priority exceptions can be reported, for example, using an email message. By way of example, the priority indications can be integrated into the control models 300 and/or the remediation recommendation database 222 such that the format of the remediation information can be selected by the remediation information generator 400 through reference to the models and/or the database.

Once the appropriate notification mechanism and format have been determined, the information can be distributed using the external remediation system 218. The external remediation system 218 can comprise each of a trouble ticket API 416, an application management alarm API 418, an email routing API 420, and a utility configuration API 422 to facilitate that distribution. The recipient for the remediation information can be determined prior to distribution using the remediation processor 220 by referencing the routing database 402, which cross-references recipient information (e.g., addresses) with the notification mechanism with which the remediation information is to be distributed. In some embodiments, the routing database 402 is organized by control or policy IDs and the subject to which the policy is being applied. For example, if the subject of a given violation is a given server, the routing database 402 may indicate the owner of that server to be the recipient of the remediation information. Defaults can be established in the routing database 402 in relation to subjects for which no specific recipient is indicated.

The status manager 412 of the remediation processor 220 can collect feedback as to resolution of the various issues for which remediation recommendations were issued. In one embodiment, the remediation information generator 400 registers issues requiring resolution with the status manager 412, which then stores in the remediation status database 414 details from the remediation, such as the control at which there was an issue, the status of the issue, and who and which external remediation system to which the issue was routed. In some embodiments, the status manager 412 includes external interfaces with which the manager can report changes in the status of the issues to the CCMM engine 308 (FIG. 3) so as to enable the CCMM engine to report on the status of remediations against a given control model 300 (FIG. 3) and report on the overall status of the remediations. In addition, the status manager 412 can be used to generate reminder tickets after an predetermined time interval has passed and the status has not been updated.

Various programs (i.e. logic) have been described herein. The programs can be stored on any computer-readable medium for use by or in connection with any computer-related system or method. In the context of this document, a computer-readable medium is an electronic, magnetic, optical, or other physical device or means that contains or stores a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

Example systems having been described above, operation of the systems will now be discussed. In the discussions that follow, flow diagrams are provided. Process steps or blocks in the flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

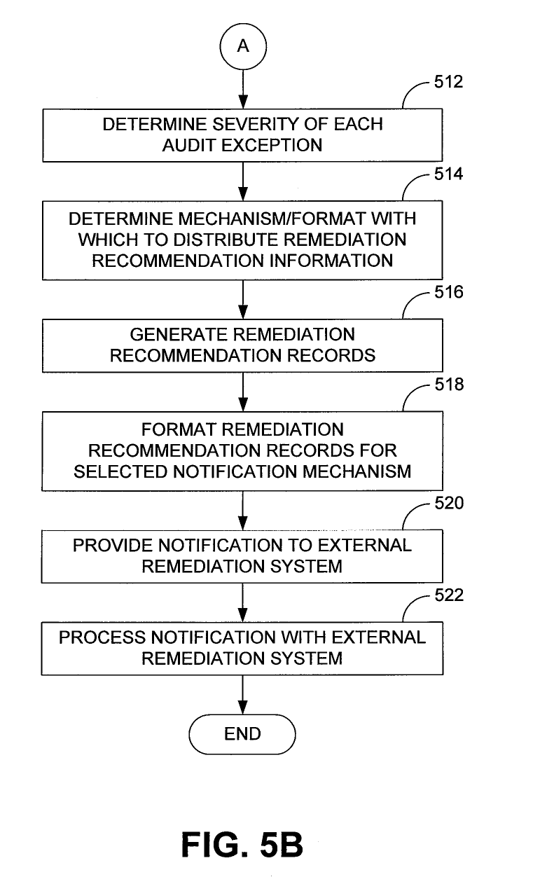

FIGS. 5A and 5B illustrate a method for automatically providing remediation recommendations relative to identified audit exceptions. In the context of this disclosure, the term “audit exception” is broadly used to identify any instance of non-compliance with an applicable standard or policy, or any other aspect that could be improved upon to improve risk management. Beginning with block 500 of FIG. 5A, an information system, and more particularly the operational infrastructure of the system, is evaluated relative to one or more control models. By way of example, the evaluation is automatically conducted by the CCMM as described above. Through the evaluation, any audit exceptions are identified, as indicated in block 502. As described above, the audit exceptions can pertain to infrastructure devices as well as applications. The nature of the audit exceptions will depend upon the policies and/or standards upon which the control models are based and can therefore take a variety of forms. Example exceptions include a terminated employee's login account still being active, a login account being inactive for an extended period of time, the age of a device being greater than an established threshold, a version of an application being beyond an established threshold, an internal procedure failing to recognize old devices/applications, absence of recommended security patches to utilized applications, failure to execute anti-virus software, a recommended device configuration not being implemented, and so forth.

Once identified, the audit exceptions are provided to the remediation information generator, as indicated in block 504, for immediate action. The remediation information generator then consults policy information from the relevant control models (block 506) and remediation text from the remediation recommendation database (block 508). Through such consultations, remediation recommendations as to how to remedy the audit exceptions can be determined, as indicated in block 510. Turning to block 512 of FIG. 5B, the priority of the audit exceptions, and therefore the importance of and/or time frame for remediation actions that must be taken, can be determined. Relative to that information, the remediation information generator can determine the notification mechanism and format with which to distribute the remediation recommendation information, as indicated in block 514.

The notification mechanism that is used as to each audit exception can depend upon the priority of the audit exception. In some embodiments, thresholds can be associated with each available mechanism, and the mechanism to be used is selected based upon which thresholds the priority of the audit exception meet or exceed. For example, for notifications to be provided to human beings, a relatively low threshold can be associated with email notifications, a relatively higher threshold can be associated with trouble ticket notifications, and a further relatively higher threshold can be associated with alarm notifications. In such a case, if a given audit exception has a priority level that surpasses the alarm notification threshold, the notification will be formatted as an alarm that alerts the responsible person that action is immediately required. If, however, the audit exception has a relatively low priority that only surpasses the email notification threshold, the notification will merely be sent as an email message. In some embodiments, thresholds can be similarly assigned to remediation actions to be identified to an automated remediation utility to indicate to the utility the order in which remediations should be processed. Therefore, the remediation information generator automatically prioritizes issues to be resolved.

In addition to using the exception priority as a guide to selecting the notification mechanism, the exception priority can also be used to determine when not to provide a notification, i.e., when to suppress notification. For example, when an audit exception comprises a relatively minor infraction that does not require immediate action, no notification may be sent to avoid inundating the responsible person with actions items. In such a case, the exception may only be identified in the report generated by the CCMM. Alternatively, a notification may be temporarily suppressed, for example until a predetermined number of days have passed or until the other, higher-priority issues have been addressed.

Assuming a notification will be distributed, the remediation information generator generates remediation recommendation records that identify the exceptions and how to resolve them, as indicated in block 516. The records are then formatted for the selected notification mechanism, as indicated in block 518. As described above, the formatting can be performed by one or more of the trouble ticket generator, alarm generator, email generator, and configuration change specification generator. The appropriate generator then provides the notification to the external remediation system, as indicated in block 520, and the external remediation system processes the notification as necessary to provide the notification to a responsible entity, as indicated in block 522.

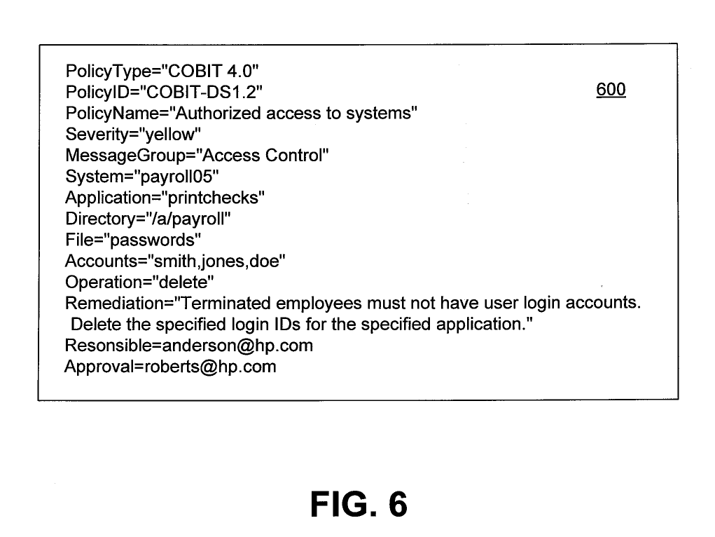

FIG. 6 illustrates a first example notification 600 containing a remediation recommendation. In the example of FIG. 6, the notification 600 can comprise the body of an email message or can be attached as a file to such an email message. As is apparent from FIG. 6, the notification 600 is formatted as a plain text file that identifies various information for the responsible person. For example, the notification 600 identifies the relevant policy or standard with which compliance was evaluated as “COBIT 4.0.” In addition, the notification 600 identifies the audit exception as a “terminated employee” still having a “user login account” and further provides a remediation recommendation of “Delete the specified login IDs for the specified application.”

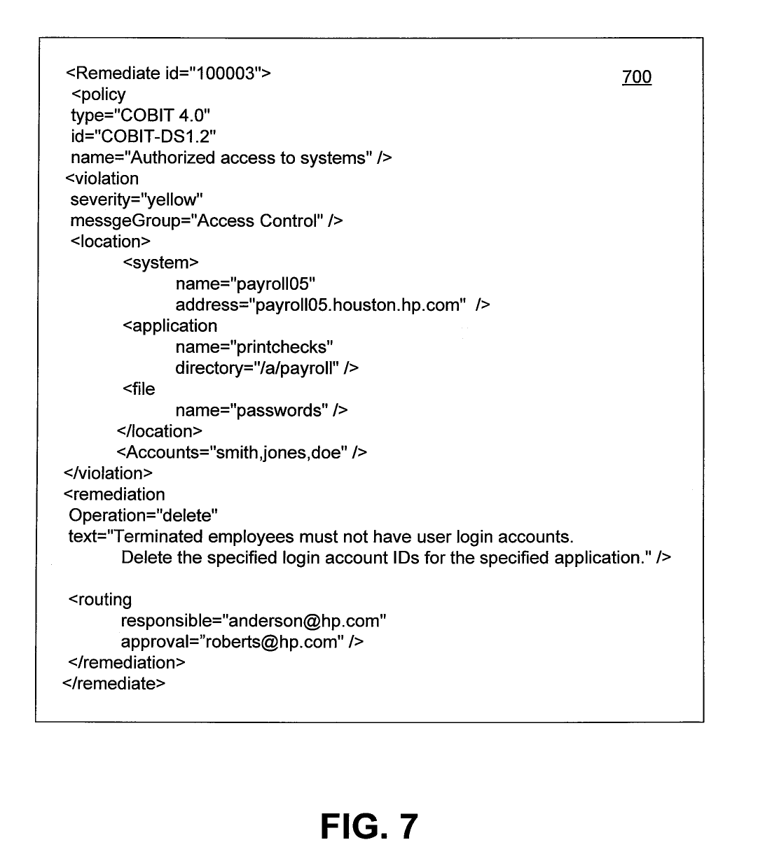

FIG. 7 illustrates a second example notification 700 containing a remediation recommendation. In the example of FIG. 7, the notification 700 comprises an extensible markup language (XML) file that can be used by an automated remediation utility charged with performing remediations. Like the notification 600, the notification 700 identifies the relevant policy with which compliance was evaluated as “COBIT 4.0,” identifies the audit exception as a “terminated employee” still having a “user login account,” and provides a remediation recommendation of “Delete the specified login IDs for the specified application.”

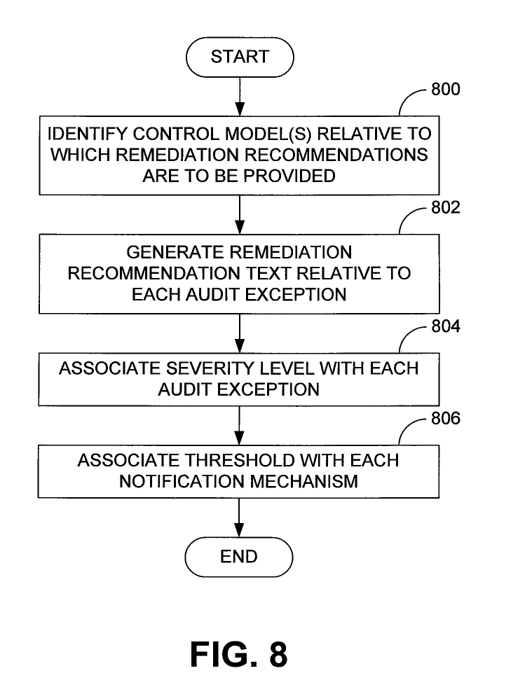

FIG. 8 illustrates a method for configuring the automated remediation recommendation system. In particular, described is a method for creating the remediation recommendations that can be provided for discovered audit exceptions and designating the priority of the exceptions to control the mechanism with which a responsible entity is notified. Beginning with block 800, control models relative to which automated remediation recommendations are to be provided are identified. Next, for each identified control model, remediation recommendation text that is to be made available for provision is generated for each audit exception, as indicated in block 802. By way of example, the remediation recommendation text is generated using the remediation recommendation GUI and is stored in the remediation recommendation database. Next, priority levels are associated with each audit exception, as indicated in block 804. As described above, the priority levels can be compared to the thresholds as to each notification mechanism to dictate the manner in which the remediation recommendation is distributed. By way of example, the priority levels are stored in association with the remediation recommendation text in the remediation recommendation database. Next, thresholds are associated with each notification mechanism, as indicated in block 806.

From the foregoing, it can be appreciated that, using the disclosed systems and methods, information systems can be more easily and more cost effectively evaluated for compliance with one or more policies and/or standards. Due to the relative ease and low cost of the automated evaluation provided by the disclosed systems and methods, such evaluations can be performed more frequently than an annual audit that is manually performed by human auditors. Assuming that problems identified through the evaluation are resolved in a timely manner, the number of issues identified by such an annual audit may be reduced, thereby lightening the workloads of persons responsible for performing remediation, such as IT professionals.

Furthermore, because the responsible entities are provided not only with an indication as to the existence of a problem but an indication as to its severity and/or time sensitivity, the responsible entity can more easily prioritize the tasks that the entity must perform to obtain compliance, thereby ensuring that the most important problems get resolved relatively quickly. In addition, given that low priority problems can be automatically suppressed, the number of tasks assigned to a given responsible entity can be better managed so as not to overwhelm that entity. Moreover, because explicit remediation instructions are provided, situations in which the responsible entity cannot fix the problem due to a lack of understanding as to how to fix the problem can be reduced.

1. A method for providing remediation recommendations, the method comprising:
receiving audit exceptions indicative of instances of noncompliance of an information system under evaluation relative to a policy or standard;
automatically identifying remediation recommendations that are relevant to the audit exceptions and that indicate how to correct conditions that caused the noncompliance; and
automatically providing the remediation recommendations to an entity responsible for correcting the conditions so as to provide information as to how the information system can be brought into compliance with the policy or standard.

2. The method of claim 1, wherein automatically identifying remediation recommendations comprises automatically identifying remediation recommendations using an automated remediation recommendation system.

3. The method of claim 2, wherein the automated remediation recommendation system consults remediation text contained in a remediation recommendation database that associates remediation recommendations with audit exceptions.

4. The method of claim 2, wherein the automated remediation recommendation system consults policy information contained within a control model that comprises a computer-readable version of the policy or standard.

5. The method of claim 1, further comprising determining priorities as to remediation of the conditions that caused the noncompliance.

6. The method of claim 5, further comprising determining notification mechanisms and formats to be used to distribute the remediation recommendations, the notification mechanisms and formats being selected relative to the determined priorities.

7. The method of claim 1, further comprising suppressing notification of an audit exception and associated remediation recommendation when an associated priority is below a predetermined threshold.

8. The method of claim 1, wherein providing the remediation recommendations comprises providing the remediation recommendations in a trouble ticket.

9. The method of claim 1, wherein providing the remediation recommendations comprises providing the remediation recommendations in an alarm message.

10. The method of claim 1, wherein providing the remediation recommendations comprises providing the remediation recommendations in or along with an email message.

11. The method of claim 1, wherein providing the remediation recommendations comprises providing the remediation recommendations in a configuration change specification to be provided to an automated remediation utility.

12. The method of claim 1, wherein providing the remediation recommendations comprises providing the remediation recommendations substantially immediately upon identification of the audit exceptions.

13. The method of claim 1, further comprising automatically evaluating the information system in relation to the policy or standard using a continuous compliance monitoring and modeling system to identify audit exceptions.

14. The method of claim 13, wherein automatically evaluating comprises automatically evaluating the information system at least on a monthly basis.

15. A system for providing remediation recommendations, the system comprising:
means for identifying remediation recommendations that are relevant to identified audit exceptions indicative of instances of noncompliance of an information system under evaluation relative to a policy or standard, the remediation recommendations indicating how to correct conditions that caused the noncompliance; and
means for providing the remediation recommendations to an entity responsible for correcting the conditions so as to provide information as to how the information system can be brought into compliance with the policy or standard.

16. The system of claim 15, wherein the means for identifying remediation recommendations comprise an automated remediation recommendation system configured to automatically consult remediation text contained in a remediation recommendation database that associates remediation recommendations with audit exceptions.

17. The system of claim 16, wherein the automated remediation recommendation system is further configured to consult policy information contained a control model that comprises a computer-readable version of the policy or standard.

18. The system of claim 15, further comprising means for determining priorities as to remediation of the conditions that caused the noncompliance.

19. The system of claim 15, further comprising means for determining a notification mechanism and format to be used to distribute the remediation recommendation.

20. The system of claim 15, further comprising suppressing notification of an audit exception and associated remediation recommendation when a priority associated with an identified condition is below a predetermined threshold.

21. The system of claim 15, further means for automatically evaluating the information system in relation to the policy or standard to identify the audit exceptions.

22. A computer-readable medium that stores an automated remediation recommendation system comprising:
a remediation recommendation database that stores multiple remediation recommendations, each remediation recommendation being associated with a requirement of a policy or standard represented by a computer-readable control model;
a remediation processor configured to (a) receive audit exceptions identified by an automated evaluation system, the audit exceptions being indicative of noncompliance of an information system under evaluation relative to the policy or standard, (b) automatically identify remediation recommendations from the remediation recommendation database that are relevant to the identified audit exceptions, the remediation recommendations describing how to correct the noncompliance, and (c) automatically generate and format a remediation recommendation record to be distributed to an entity responsible for correcting the conditions.

23. The computer-readable medium of claim 22, wherein the automated remediation recommendation system further comprises a remediation recommendation graphical user interface (GUI) that can be used to configure the automated remediation recommendation system.

24. The computer-readable medium of claim 23, wherein the remediation recommendation GUI can be used to establish priorities as to remediation of conditions the result in noncompliance.

25. The computer-readable medium of claim 22, further comprising a status manager that tracks remediation progress and generates reminders when remediation has not been detected as having being completed.
